(19) United States
(12) Patent Application Publication
(10) Pub. No.: US 2016/0301658 A1
(43) Pub. Date: Oct. 13, 2016

(54) METHOD, APPARATUS, AND COMPUTER-READABLE MEDIUM FOR EFFICIENT SUBNET IDENTIFICATION

(71) Applicant: X15 Software, Inc., Burlingame, CA (US)

(72) Inventor: Vinayak Borkar, San Jose, CA (US)

(21) Appl. No.: 14/684,307

(22) Filed: Apr. 10, 2015

(51) Int. Cl. H04L 29/12

(52) U.S. Cl. CPC H04L 61/1552; H04L 61/6068

(57) ABSTRACT

An apparatus, computer-readable medium, and computer-implemented method for efficiently identifying a subnet including sorting a plurality of Internet Protocol (IP) address ranges to generate a sorted list of IP address ranges and determining one or more result IP address ranges in the sorted list of IP address ranges which contain an IP address based at least in part on one or more binary searches of the sorted list of IP address ranges, the one or more binary searches utilizing one or more search keys that are based at least in part on the IP address.

### BACKGROUND

FIG. 1 illustrates a join process between two tables, the employee table 101 and the department table 102. The query 103 is used to join the two tables such that every record in the employee table 101 is joined with those records in the department table 102 where the department code in the employee table 101 is equal to the department code in the employee table 102. The result set of the join is shown at 104.

FIG. 1 illustrates an example of an equi-join operation, where the records from the two tables are joined based on an equality comparison operator in the join-predicate (the where statement).

One type of non equi-join operation relies on the containment operator “<<” which evaluates whether a first quantity is contained within a second quantity. For example, FIG. 2 illustrates an example of a sub-network (“subnet”) containment operator in the predicate 201 which evaluates whether Internet Protocol (IP) address 192.168.10.12 is contained within the IP address range 192.168.0.0/16.

The IP address shown on the left side of predicate 201 in FIG. 2 is an IPv4 address and consists of four bytes (32 bits). These bytes are also known as octets. For readability purposes, IP addresses are typically expresses in a notation called dotted decimal. This notation places periods between each of the four numbers (octets) that comprise an IP address. For example, the IP address shown as 192.168.10.12 in predicate 201 could also be expressed as the binary number “11000000.10101000.00001010.00001100” shown in expanded predicate 202.

The IP address range 192.168.0.0/16 shown on the right side of predicate 201 is an example of Classless Inter-Domain Routing (CIDR) notation and includes an IP address (“192.168.0.0”) and a number of significant bits in the associated network mask (“16”). For example, the IP address range expressed as 192.168.0.0/16 includes all IP addresses from 192.168.0.0 to 192.168.255.255 since only the first sixteen bits (the first two octets) are “1” in the associated network mask. In other words, the number after the slash is the bit mask for the network. Simply put, it denotes how many bits are the same for each IP address in the IP address range. It also indicates which parts of the IP addresses in the IP address range can vary. In this case the first 16 bits must be the same for each IP address in the IP address range.

Therefore, the determination of whether IP address 192.168.10.12 is contained within the range 192.168.0.0/16, involves comparing the first 16 bits of 192.168.10.12 with the first 16 bits of 192.168.0.0, as shown in predicates 202 and 203 of FIG. 2. As shown in predicate 203, the first 16 bits of 192.168.10.12 are equal to the first 16 bits of 192.168.0.0. Therefore, the IP address 192.168.10.12 is a subnet of 192.168.0.0/16, as indicated at 204.

Generally, an IP address (xxx.xxx.xxx.xxx/32) is contained within a subnet (xxx.xxx.xxx.xxx/yy) if the first yy bits of the subnet address are equal to the first yy bits of the IP address. In other words, the first yy bits form a prefix of the IP address. The same principle applies when the left side of the << operator is a subnet. In addition to the above requirement of containment (prefix match), the number of significant bits in the subnet on the left (the number after the /) must be greater than or equal to yy.

FIG. 3 illustrates an example of a containment join operation between Table A 301 and Table B 302 such that every record in Table A 301 is joined with those records in Table B 302 wherein the IP Address (A.IP_Address) is contained in or equal to a subnet (B.CIDR), which represents an IP address range. Unlike, the regular containment operator, <<, containment equals operator <<= includes records in the IP address range which are equal to the IP address on the left side of the operator. The query for performing the join operation is shown in box 303 and the result set of the join is shown at 304.

Unfortunately, when the data sets involved include a large number of records, performing a join operation based on the subnet operator can be time consuming and computationally expensive, as each IP address in the first table must be compared to each IP address range in the second table to identify whether the IP address is a subnet of the IP address range. These problems also arise in other contexts, such as packet routing, when a target IP address of millions of packets must be matched to interfaces identified by IP address ranges denoted in CIDR notation.

### BRIEF DESCRIPTION OF THE DRAWINGS

FIG. 1 illustrates a join operation between two tables.

FIG. 2 illustrates an example of containment predicate with an IP address and a CIDR.

FIG. 3 illustrates a containment join between two tables with an IP address as the join key.

FIGS. 4A-4C illustrate a block nested-loops join strategy for performing the containment join of FIG. 3.

FIG. 5 illustrates a flowchart for efficient subnet identification according to an exemplary embodiment.

FIG. 6 illustrates a flowchart for efficient subnet identification using a plurality of search keys generated from an IP address according to an exemplary embodiment.

FIG. 7 illustrates an example of subnet identification using the method described in FIG. 6.

FIGS. 8A-8B illustrate a process flow diagram and algorithm for efficient subnet identification using a plurality of search keys generated from an IP address according to an exemplary embodiment.

FIG. 9 illustrates a flowchart for efficient subnet identification using parent pointers according to an exemplary embodiment.

FIGS. 10A-10B illustrate a process flow diagram and algorithm for generation of parent pointers according to an exemplary embodiment.

FIGS. 11A-11B illustrate an example of parent pointer generation using the process flow and algorithm described in FIGS. 10A-10B.

FIG. 12 illustrates an execution path of the algorithm of FIG. 10B for an example set of sorted IP address ranges.

FIG. 13 illustrates a process flow diagram for efficient subnet identification using parent pointers according to an exemplary embodiment.

FIG. 14 illustrates an algorithm for efficient subnet identification using parent pointers according to an exemplary embodiment.

FIGS. 15A-15B illustrate a first example of efficient subnet identification using parent pointers for a first IP address according to an exemplary embodiment.

FIG. 16 illustrates a second example of efficient subnet identification using parent pointers for a second IP address according to an exemplary embodiment.

FIG. 17 illustrates a third example of efficient subnet identification using parent pointers for a third IP address according to an exemplary embodiment.

FIG. 18 illustrates an exemplary computing environment that can be used to carry out the method for efficient subnet identification according to a disclosed embodiment.

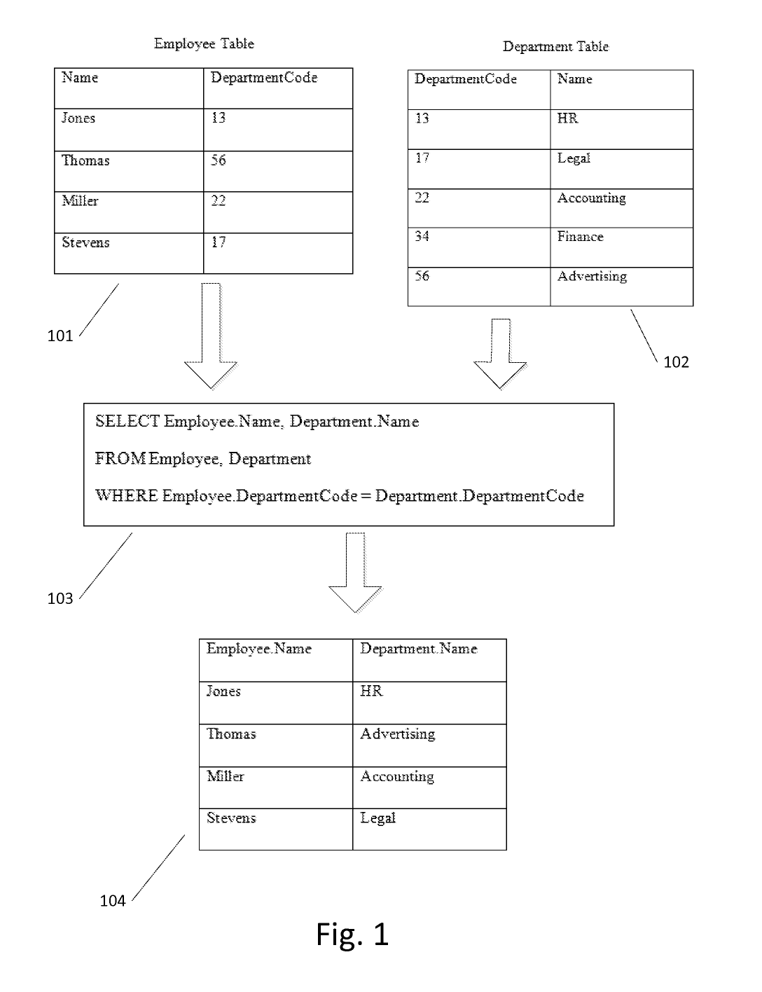

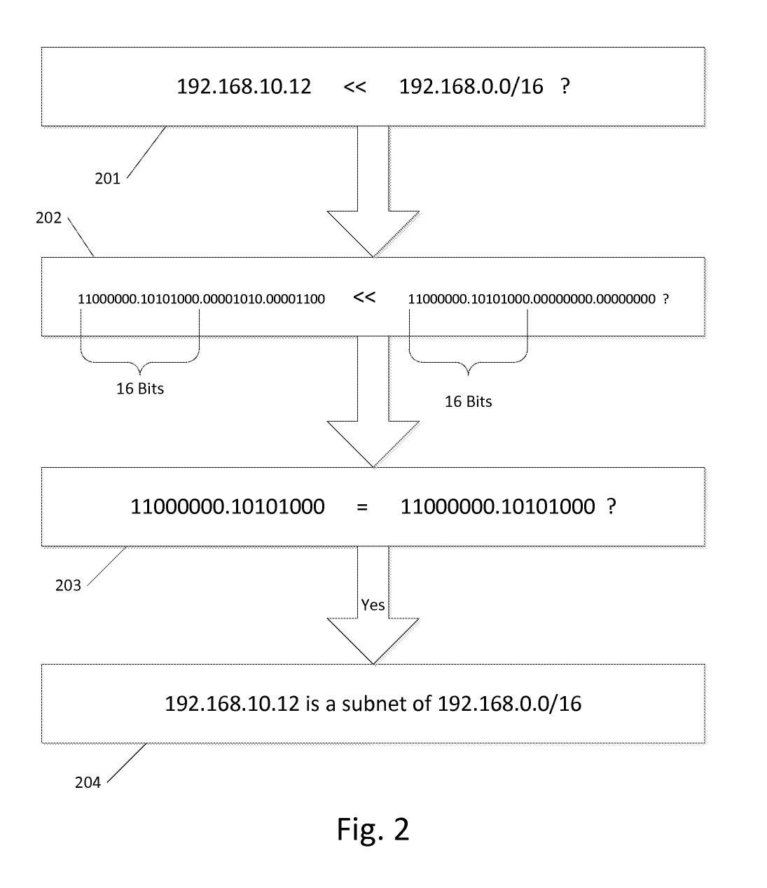

### DETAILED DESCRIPTION

While methods, apparatuses, and computer-readable media are described herein by way of examples and embodiments, those skilled in the art recognize that methods, apparatuses, and computer-readable media for efficient identification of subnets are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

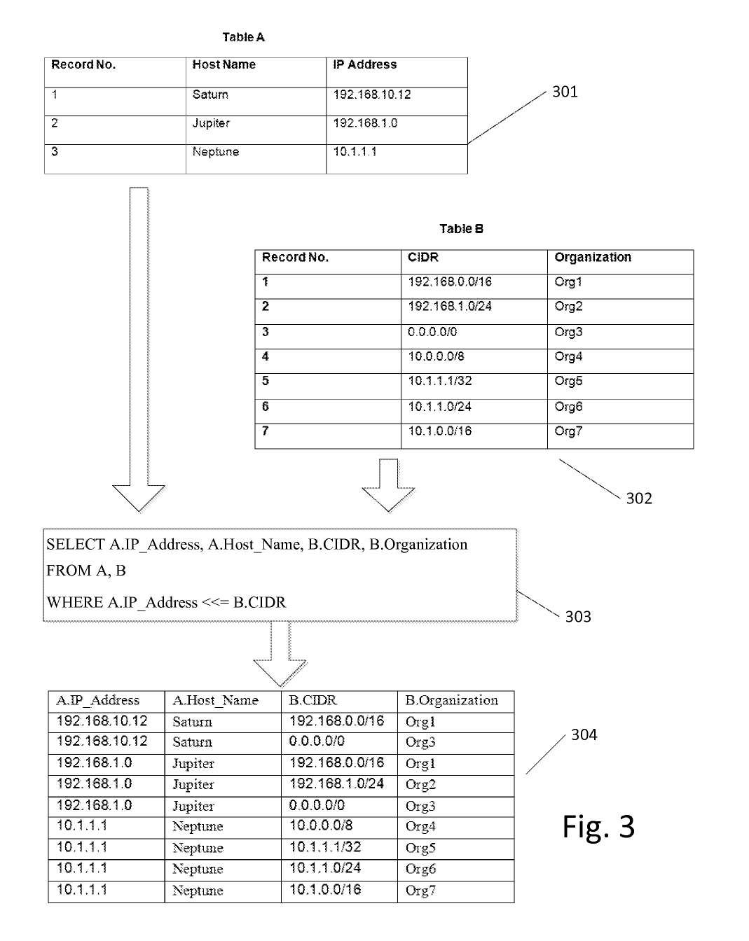

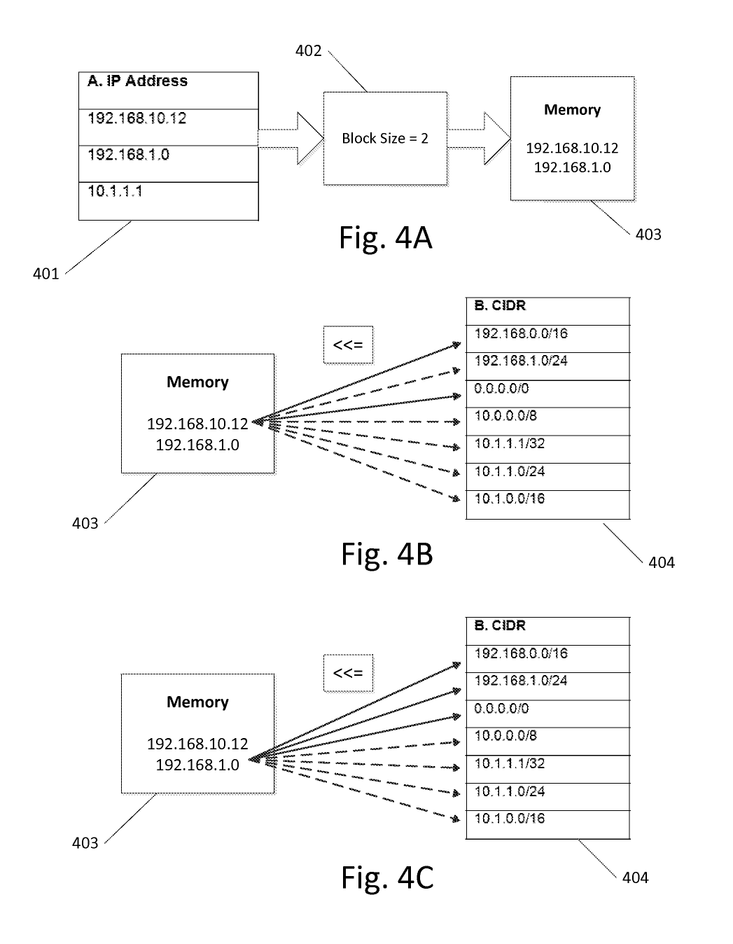

The Applicant has identified a need to more efficiently identify subnets of IP addresses, such as for the purposes of performing containment joins. FIG. 4 illustrates an example of a basic join strategy used to join the two tables, 301 and 302, shown in FIG. 3 according to the parameters of the query 303 shown in FIG. 3. The strategy illustrated in FIGS. 4A-4C is referred to as a Block Nested-Loops strategy and involves iterating over the records on the left of the join, and for each block of records, iterating over the records on the right side and invoking the <<= operator for each pair of records.

For example, as shown in FIG. 4A, if the join keys for the left side of the join predicate (the IP addresses being evaluated as part of the join predicate) are given as column 401 and the block size is equal to 2, then the first two IP addresses can be read into memory 403 as part of the first block.

As shown in FIG. 4B, the first of these IP addresses is then compared to each of the join keys for the right side of the join predicate 404 (the IP address ranges being evaluated as part of the join predicate) using the containment equals operator <<=. Pairs where the IP address is contained within (or equal to the edge values) of an IP address range are indicated with a solid line, whereas as a dashed line indicates pairs where the IP address is not contained (or equal to the edge values) of an IP address range. For example, IP address 192.168.10.12 is a subnet of 192.168.0.0/16 but is not a subnet of 192.168.1.0/24 because the third octet of the IP address is outside the range of 192.168.1.0/24 which requires that the third octet be equal to 1 (since there are 24 significant bits).

Similarly, FIG. 4C illustrates the comparisons required between the second of the IP addresses and each of the IP address ranges 404. As shown by the three solid lines in FIG. 4C, there are three IP address ranges which contain (or have edge values equal to) 192.168.1.0. These are 192.168.0.0/16, 192.168.1.0/24, and 0.0.0.0/0. Of course, if the operator were a pure containment operator “<<” rather than containment-equals “<<=”—then 192.168.1.0/24 would not be part of this set since 192.168.1.0 is not contained within the IP address range 192.168.1.0/24.

The process shown in FIGS. 4A-4C would then have to be repeated after loading the next block of join keys on the left side of the join predicate (in this case, IP address 10.1.1.1). As shown in FIGS. 4A-4C, this join process requires multiple loading (input/output) operations and multiple levels of comparisons. Given a number of first join keys R and a number of second join keys S, the cost vector (CV) for this join operation would be given as:

CV=[R*S, R*S/B, 0], where B is the block size and the cost vector specifies [CPU cost, Input/Output cost, Network cost].

The Applicant has discovered a way to more efficiently identify subnets (IP address ranges) containing IP addresses which reduces algorithmic and computational costs and which provides the same result set as existing methods in a much shorter period of time. Of course, the process and system described herein is not limited to identifying IP address ranges which contain an IP address and can be used for any prefix query, such as containment operations on strings and substrings. Additionally, the methods and systems for efficient subnet identification disclosed herein can be used in packet routing and networking applications which require determination of a target interface for a particular packet based on a subnet operation involving a target IP address of the packet and different subnets corresponding to different possible routing paths.

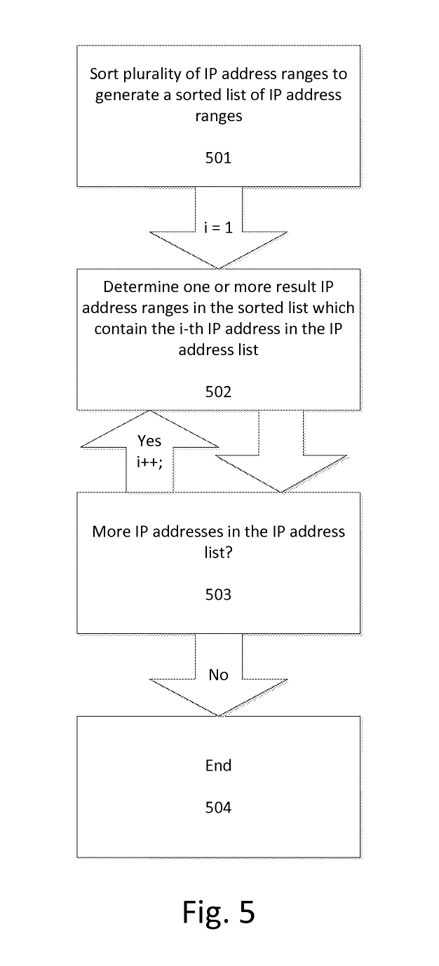

FIG. 5 illustrates a flowchart for efficient subnet identification according to an exemplary embodiment. It is assumed that there is a list of IP addresses containing one or more IP addresses and a plurality of IP address ranges which are to be evaluated against the list of IP addresses using either the containment or containment equals operation. Each IP address range in the plurality of IP address ranges can comprises an IP address and an associated network mask and can be expressed in Classless Inter-Domain Routing (CIDR) notation, as discussed earlier.

At step 501, the plurality of IP address ranges are sorted to generate a sorted list of IP address ranges. There are a variety of ways the sorting can be performed.

For example, the sorting can be performed by comparing a first bit string corresponding to a first IP address range in the plurality of IP address ranges with a second bit string corresponding to a second IP address range in the plurality of IP address ranges, and sorting the first IP address range and the second IP address range based at least in part on the comparison. This can be repeated for all IP address ranges in the plurality of IP address ranges.

When the IP address ranges are in CIDR notation, this sorting can be performed by defining compare(C1, C2) to be consistent with string-compare(bitstring(C1.bits, C1.width), bitstring(C2.bits, C2.width)).

Additionally, the sorting can be performed by storing a first IP address range in the plurality of IP address ranges as a first fixed-width byte sequence, storing a second IP address range in the plurality of IP address ranges as a second fixed-width byte sequence, comparing the first fixed-width byte sequence with the second fixed-width byte sequence, and sorting the first IP address range and the second IP address range based at least in part on the comparison. This can be repeated for all IP address ranges in the plurality of IP address ranges.

When the IP address ranges are in CIDR4 notation (CIDR notation for IPv4 address ranges), the fixed width byte sequence can be: [<width bits><32−width 0 bits><width>]. Byte comparison can then be used to compare the various CIDRs and perform the sorting. Such a comparison has the property that every prefix of any IP address range (CIDR) appears before that IP address range. Another way of thinking about this sort order is that it is the order that would be produced by traversing a trie that is built using the bits in the CIDR, such that a 0 bit sorts before a 1 bit at the same level, and then performing a pre-order traversal of the trie. In the trie so constructed, a CIDR (C1) that is a prefix of another CIDR (C2) in the same dataset is guaranteed to be a parent of C2 in the trie. Hence in the pre-order traversal, C1 will appear before C2.

Although the above sections describe the sort order of IP address ranges as ascending lexicographic order, the sort order of the IP address ranges can also be a descending order without deviating from the scope of the systems and methods disclosed herein.

Returning to FIG. 5, for the first IP address in the one or more IP addresses, one or more result IP address ranges in the sorted list of IP address ranges are determined at step 502. As will be explained in greater detail, the one or more result IP address ranges are IP address ranges which contain the IP address and are determined based at least in part on one or more binary searches of the sorted list of IP address ranges. As is also explained in greater detail below, this binary search of the sorted list of IP address ranges utilizes one or more search keys that are based at least in part on the IP address that is being searched for.

At step 503 it is determined whether there are any more IP addresses in the list of IP addresses. If there are not, then the process ends at step 504. Otherwise, step 502 is repeated for the next IP address in the list of IP addresses, meaning that one or more second result IP address ranges are determined which contain the next IP address. These steps can be repeated until result IP address ranges are determined for each IP address in the list of IP addresses.

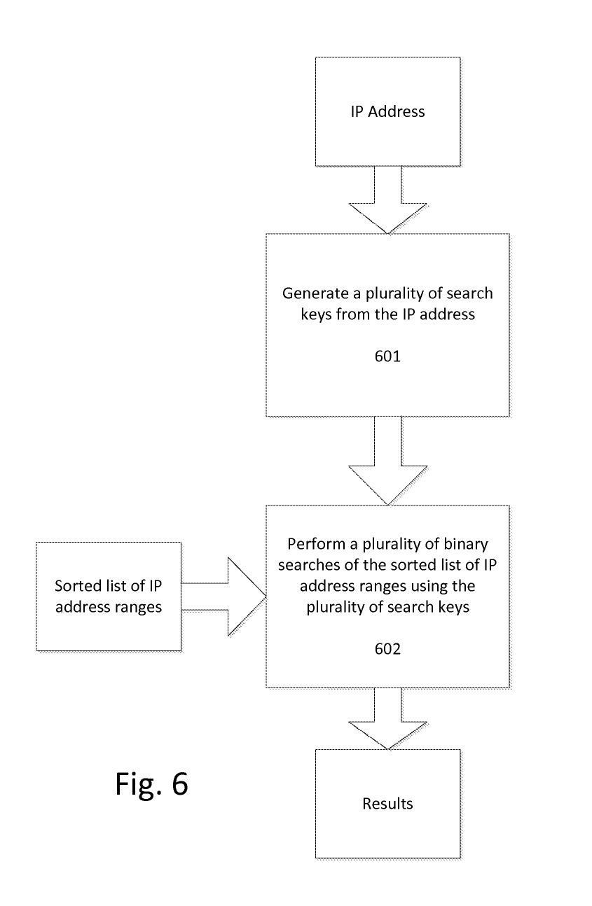

FIG. 6 illustrates a flowchart for determining one or more result IP address ranges in the sorted list of IP address ranges which include an IP address based at least in part on one or more binary searches of the sorted list of IP address ranges.

At step 601 a plurality of search keys are generated from the IP address, which can be an input to the step. The plurality of search keys are generated such that each search key in the plurality of search keys incorporates a unique number of significant bits from the IP address and such that the total number of search keys is equal to the total number of significant bits in the IP address. For example, a first search key could have 1 significant bit incorporated from the IP address with all of the other bits set to zero. A second search key could have 2 significant bits incorporated from the IP address with all of the other bits set to zero.

At step 602 a plurality of binary searches of the sorted list of IP address ranges are performed using the plurality of search keys to identify any IP address ranges in the sorted list of IP address ranges which match (are equal to) the plurality of search keys.

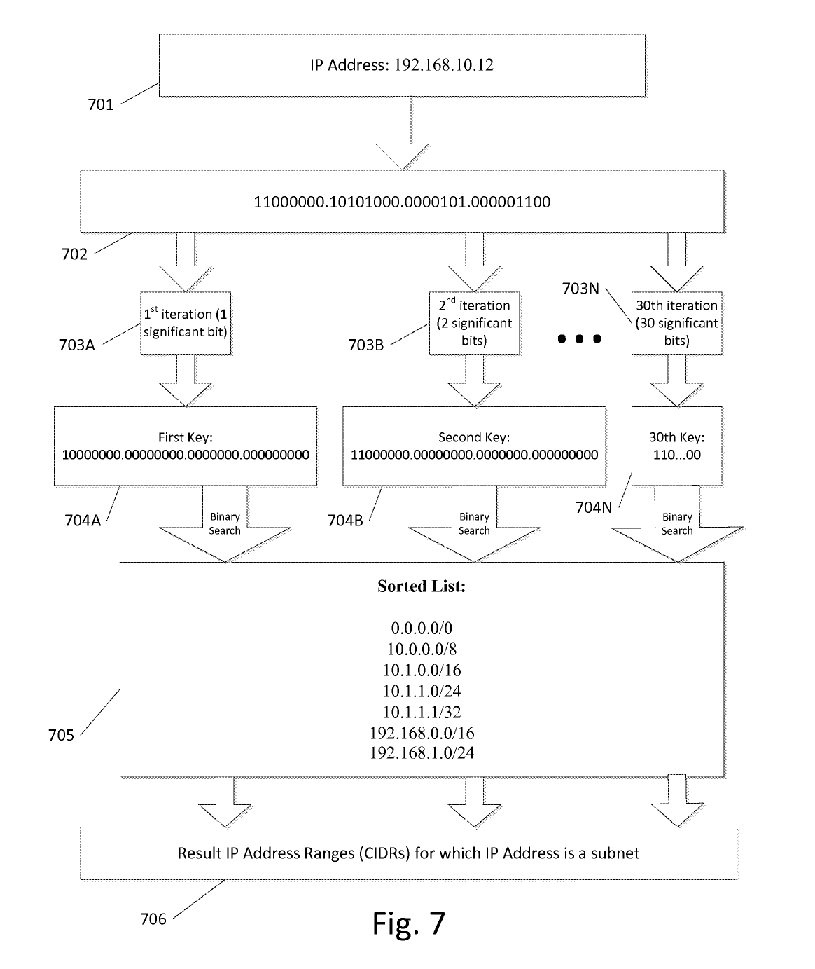

FIG. 7 illustrates an example of the process described in FIG. 6. Box 701 of FIG. 7 shows the input IP address in dot-decimal notation and box 702 shows the same input IP address in binary notation. As shown in box 702, although the total length of the IP address is 32 bits, there are only 30 significant bits (the last two bits are zero). Therefore, when generating the plurality of search keys from the IP address, thirty iterations of the key generation process will be performed, as shown in boxes 703A, 703B, and 703N.

These thirty iterations will result in thirty different keys, each having a different number of significant bits, as shown in boxes 704A, 704B, and 704N. For example, the second key 704B incorporates two significant bits from the IP address, and since the first two bits of the IP address 702 are both “1,” the second key 704B begins with two “1”s.

These keys are then used to perform a binary search of the sorted list of IP address ranges 705. These binary searches will produce will one or more result IP address ranges 706 for which the IP address is a subnet (meaning one or more result IP address ranges which contain the IP address).

The process described in FIGS. 6-7 performs a prefix search for each possible prefix of the IP address within the sorted list of IP address ranges. When a prefix is found in the sorted list of IP address ranges, it can be added to the result list, since that IP address range must necessarily include the IP address for which it is a prefix. For example, the sixteenth key for the IP address 701 shown in FIG. 7 will be 192.168.0.0 (since it will include 16 significant bits). When this key is found in the sorted list of IP address ranges (as 192.168.0.0/16), that IP address range can be added to the result list for the IP address 192.168.10.12. A key can be considered to match an IP address range when all of the bits in the key match all of the bits in the IP address range.

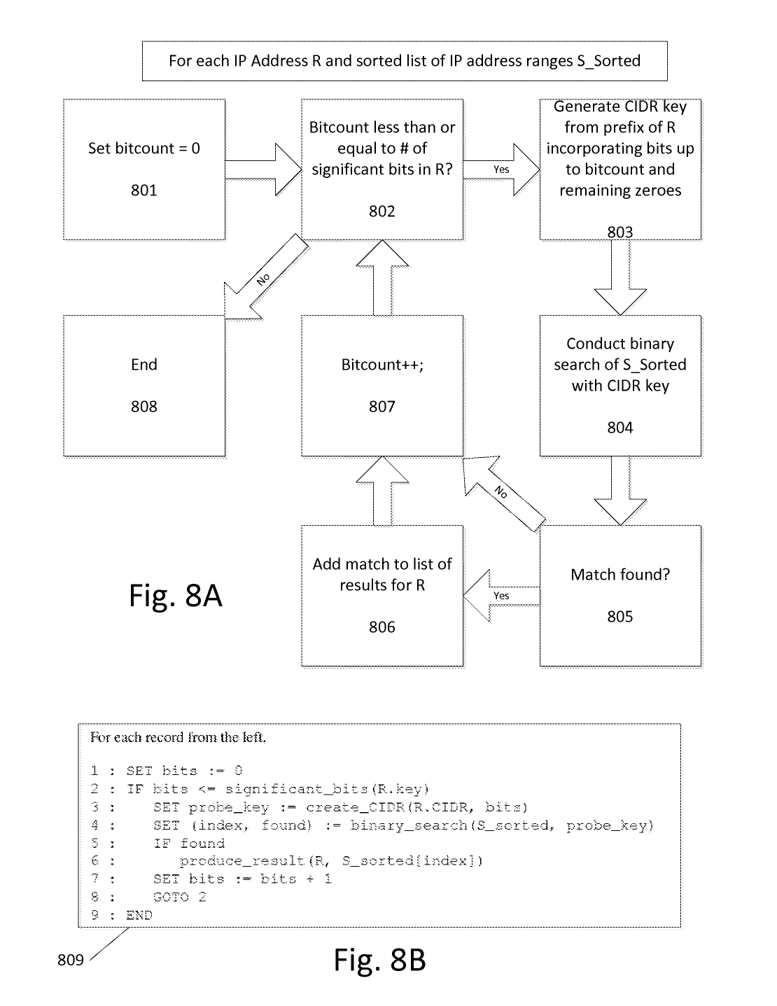

FIGS. 8A-8B illustrate an algorithm 809 and corresponding flowchart that can be used to implement the process described in FIGS. 6-7. The algorithm and flowchart describe the process for each IP address R and a sorted list of IP address ranges S-Sorted. At step 801, the bitcount is set to zero. At step 802 it is determined whether the bitcount is less than or equal to the number of significant bits in R. If the bitcount is greater than the number of significant bits in R, the process ends at step 808.

Otherwise, if the bitcount is less than or equal to the number of significant bits in R, then a CIDR key (to be used as a search key) is generated from a prefix of R at step 803. The CIDR key incorporates bits up to the bitcount and fills the remainder of the key with zeroes. At step 804 a binary search of S-sorted is conducted with the CIDR key. At step 805 it is determined whether there are any matching results. If there are no matches, then the process proceeds to step 807.

If there are matching results, then the matches are added to the list of results for R at step 806. The process then proceeds to step 807 where bitcount is incremented by one. After step 807 the process returns to step 802, which is repeated for the current value of bitcount. The steps continue in this manner until bitcount is greater than the number of significant bits in R.

Since the search that is being performed for each key is a binary search, it requires only logarithmic processing time to find the result sets, improving overall processing time compared to the method described in FIGS. 4A-4C. In particular, given a number of first join keys R and a number of second join keys S, the cost vector (CV) for this join operation would be given as: CV=[(R*W+S)*log(S), 0, 0], where W is the width of the values being compared (for example, for IPv4 addresses, W is 32) and the cost vector specifies [CPU cost, Input/Output cost, Network cost].

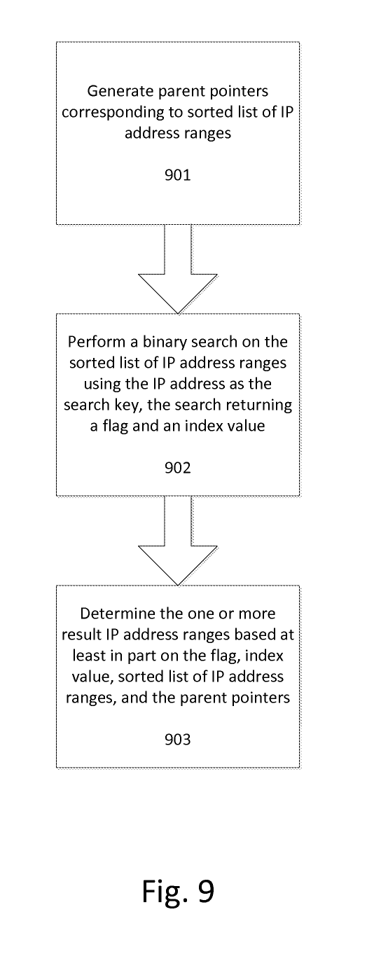

However, further improvement of this method is possible. FIG. 9 illustrates a flowchart for another method of determining one or more result IP address ranges in the sorted list of IP address ranges which include an IP address which further improves the processing time and reduces computational complexity.

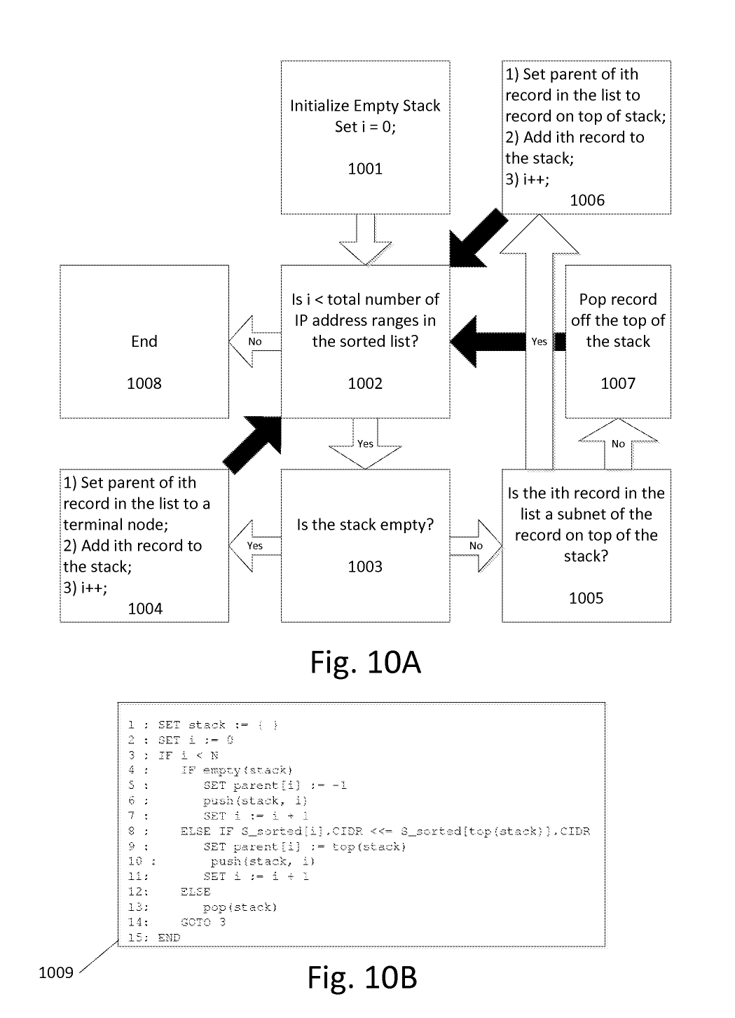

At step 901, a list of parent pointers corresponding to the sorted list IP of address ranges are generated. As will be explained in greater detail with respect to FIGS. 10A-10B, 11A-11B, and 12, each parent pointer in the list of parent pointers corresponds to an IP address range in the sorted list of IP address ranges and points to either another IP address range in the sorted list IP of address ranges or a terminal node.

At step 902, a binary search is performed on the sorted list of IP address ranges using the IP address as a search key. The binary search returns a flag indicating whether the sorted list of IP address ranges contains the search key and an index value corresponding to either a location of the search key in the sorted list of IP address ranges or a search index value at termination of the binary search.

At step 903, the one or more result IP address ranges which contain the IP address are determined based at least in part on the flag, the index value, the sorted list of IP address ranges, and the list of parent pointers.

FIG. 10B illustrates an algorithm for generating parent pointers 1009 and the corresponding process flow diagram is shown in FIG. 10A. The algorithm receives as input the sorted list of IP address ranges that was previously generated. At step 1001 an empty stack is initialized and the index value i is set to zero. At step 1002 it is determined whether i is less than the total number of IP address ranges in the sorted list of IP address ranges.

If i is greater than or equal to the total number of IP address ranges in the sorted list of IP address ranges, then all of the IP address ranges have already been assigned parent pointers and the process ends at step 1008.

Otherwise, at step 1003, it is determined whether the stack is currently empty. If the stack is empty, then at step 1004 the parent of the ith record in the sorted list is set to a terminal node (such as −1), the ith record is added to the stack, and i is incremented by 1. Processing then returns to step 1002 with the new value of i.

If the stack is not empty, then at step 1005 it is determined whether the ith record in the sorted list of IP address ranges is a subnet of the record on top of the stack (whether the IP address range of ith record in the sorted list is contained within the IP address range of the record on top of the stack). If the ith record in the sorted list of IP address ranges is not a subnet of the record on top of the stack, then the top record is popped off the stack at step 1007 and the process returns to step 1002.

Otherwise, if the ith record in the sorted list of IP address ranges is a subnet of the record on top of the stack, then at step 1006, the parent of the ith record in the list is set to the record on top of the stack, the ith record is added to the stack, and i is incremented by 1. Processing then returns to step 1002 with the new value of i.

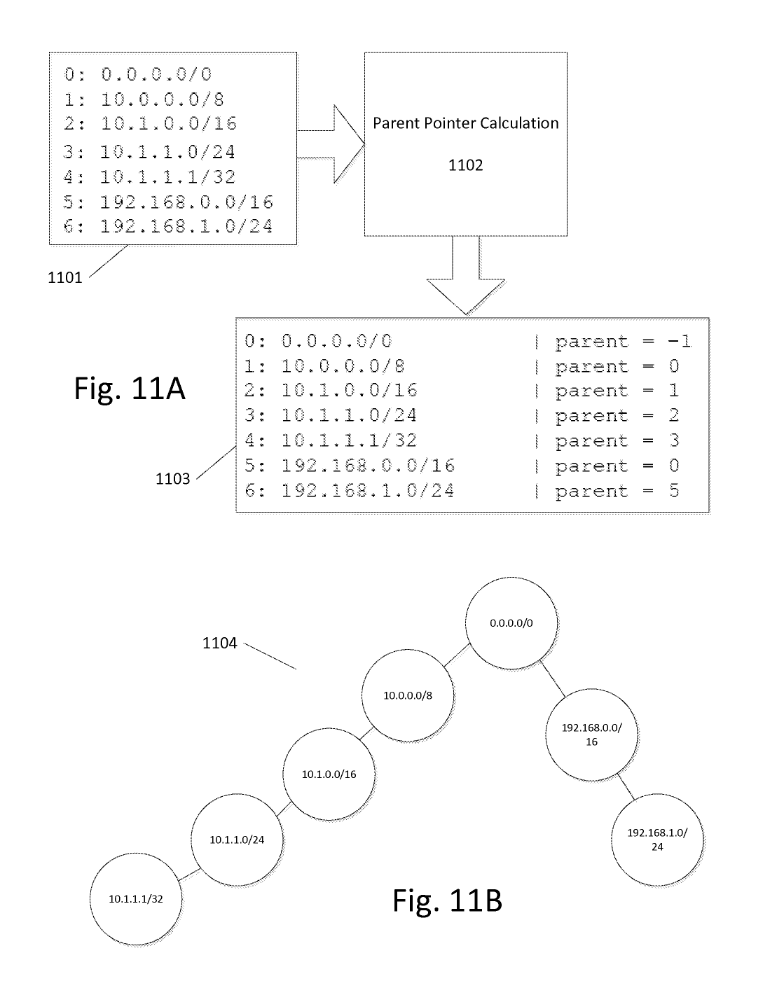

FIGS. 11A-11B illustrate an example of the process for generating parent pointers using a sorted list of IP address ranges 1101 generated from the example in FIG. 3. As shown in FIG. 11A, the sorted list 1101 is input to the parent pointer generating algorithm 1102, resulting in the sorted list and parent pointers shown in box 1103.

FIG. 11B illustrates the parent-child relationships of each of the IP address ranges in the sorted list in a tree diagram 1104. As shown in the tree diagram 1104, the parent of the 5^{th} node in the sorted list (192.168.0.0/16) is the 0^{th} node, which is 0.0.0.0/0. Another example is that the sixth node in the sorted list (192.168.1.0/24) is the child of the 5^{th} node, which is 192.168.0.0/16. As shown in FIGS. 11A-11B, each parent pointer in the list of parent pointers points to either a terminal node or to an IP address range in the sorted list IP of address ranges which encompasses the IP address range corresponding to that parent pointer and which is the next largest IP address range in the sorted list IP of address ranges.

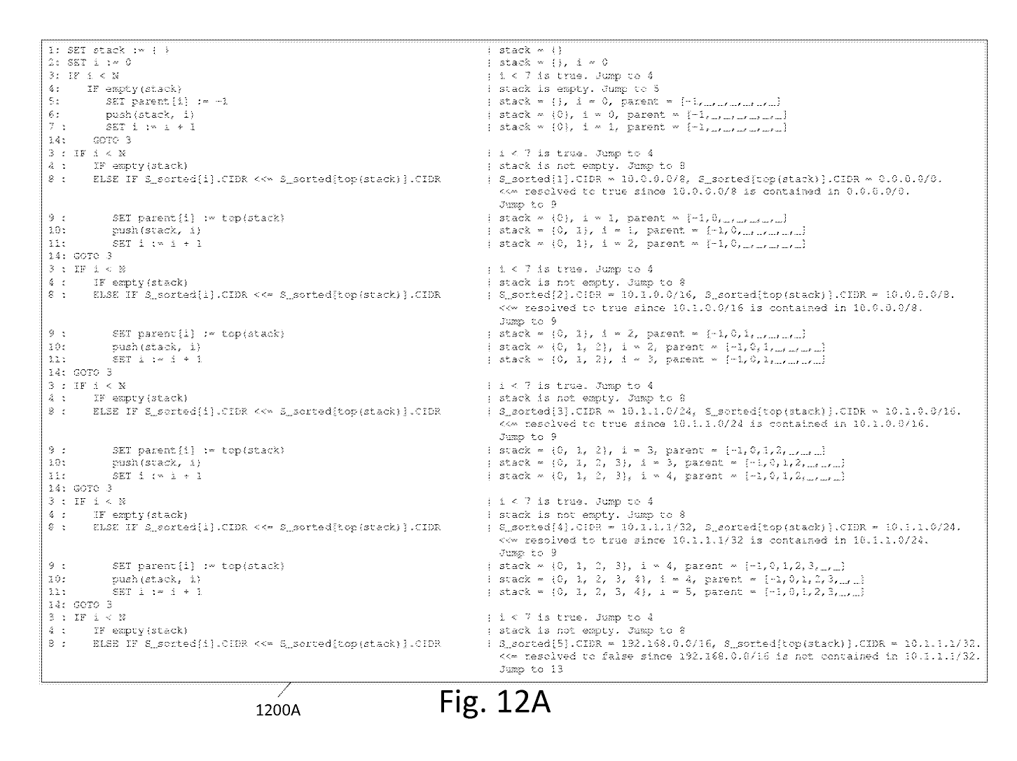

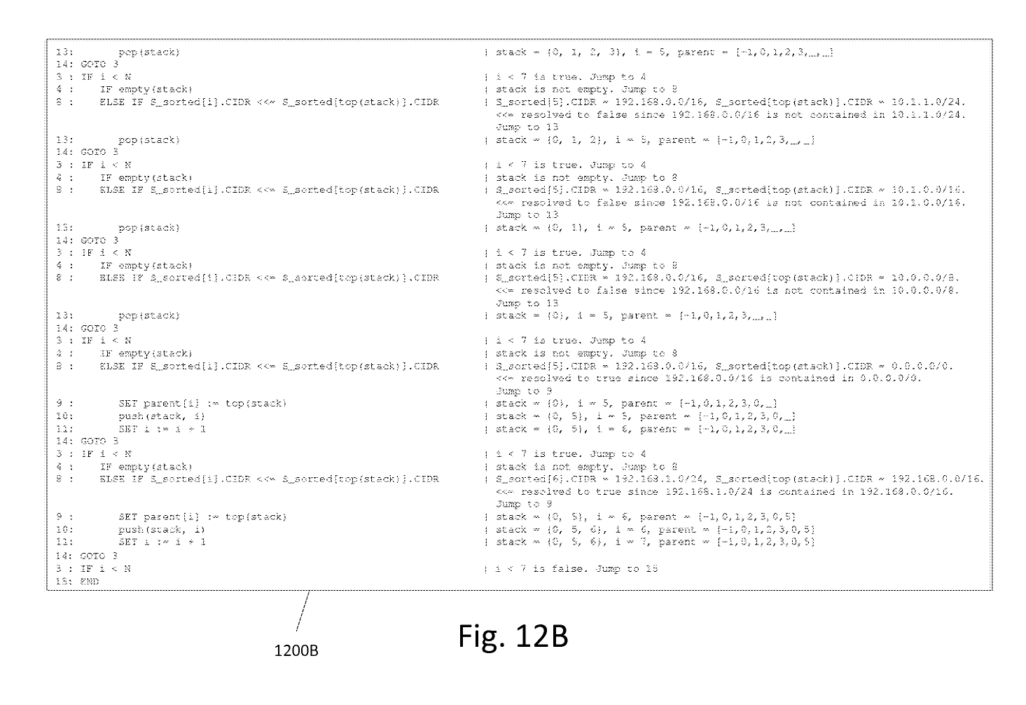

FIG. 12 illustrates the execution path 1200 of the parent pointer generation algorithm 1009 of FIG. 10B using the sorted list of IP address ranges 1101 presented in FIG. 11A. The left column of the execution path 1200 indicates the line of code that is executed at each point in the algorithm and the right column of the execution path provides commentary and the values of the stack and list of parent pointers corresponding to each line.

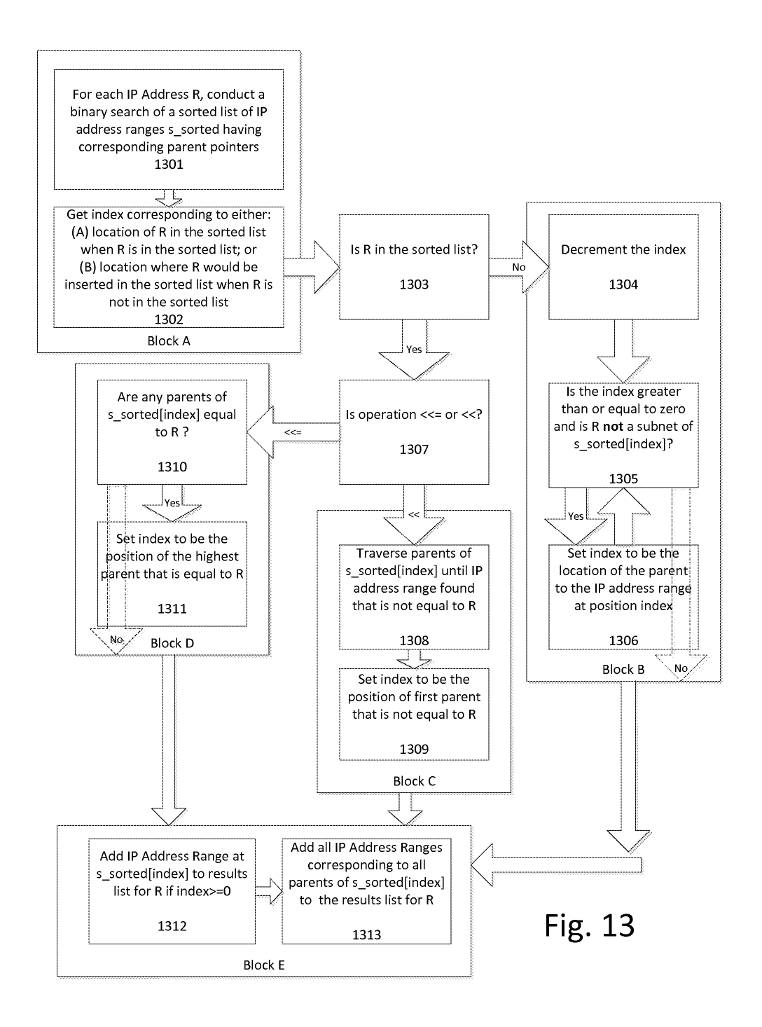

As discussed above, the parent pointers can be utilized along with the sorted list of IP address ranges to more efficiently identify all IP address ranges which contain a particular IP address. FIG. 13 illustrates a flowchart for utilizing the parent pointers in conjunction with a sorted list of IP address ranges s_sorted in order to identify all IP address ranges which contain a particular IP address R. As shown in this flowchart, only a single binary search is required for each IP address R, reducing the multiple iterations required for each significant bit described with respect to FIGS. 6-8B.

At step 1301, for each IP address R, a binary search is performed on the sorted list of IP address ranges using the IP address R as a search key. The binary search returns a flag indicating whether the sorted list of IP address ranges contains the IP address R.

At step 1302, an index value is returned as a result of the binary search which corresponds to either a location of the IP address R in the sorted list of IP address ranges when R is in the sorted list of IP address ranges or a search index value at termination of the binary search when R is not in the sorted list of IP address ranges. When R is not in the sorted list of IP address ranges, the index value will correspond to the location where R would be inserted in the sorted list.

At step 1303 it is determined whether the IP address R is in the sorted list of IP address ranges. This can be determined by checking the flag that is returned as a result of the binary search.

If R is not in the sorted list of IP address ranges, then processing proceeds to Block B and step 1304. At step 1304 the returned index value is decremented. This has the effect of shifting to the next largest IP address range in the sorted list of IP address ranges. At step 1305 it is determined whether the index value is greater than or equal to zero and whether the IP address R is not a subnet of the IP address range at the position of index in the sorted list of IP address ranges. If the IP address R is not a subnet of the IP address range at the position of index in the sorted list of IP address ranges, then at step 1306 the index value is set to be the location of the parent record of the IP address range at the current position of the index and processing returns to step 1305. If it is determined at step 1305 that either the index value is less than zero (meaning a terminal node has been hit) or that the IP address R is a subnet of the IP address range at the position of index, then processing proceeds to block E and step 1312, which is discussed further below. The effect of steps 1305 and 1306 is to identify the smallest IP address range in the list of sorted IP address ranges which contains the IP address R.

Returning to step 1303, if it is determined that the IP address R is in the sorted list of IP address ranges, then processing proceeds to step 1307 where it is determined whether the operation is a strict containment operation << or a containment-equals operation <<=. As discussed earlier, a strict containment operation only returns results within a particular address range and not at the end of the range, whereas a containment-equals operation includes endpoint values. The method can include receiving an input indicating whether the operation is a strict containment operation or a containment-equals operation. This input can be used to make the determination in step 1307.

If the operation is a strict containment operation, then processing proceeds to block C and step 1308. Since the operation is strict containment, any records in the sorted list of IP address ranges which are equal to the IP address R will have to be filtered out of the potential result set. An IP address range (such as one expressed in CIDR notation) can be considered equal to an IP address when all of the bits in the IP address range match the bits of the IP address. For example, the IP address range 192.168.1.0/24 would be considered equal to the IP address 192.168.1.0. At step 1308 the sorted list of IP address ranges is traversed starting with the IP address range at position index using parent pointers until an IP address range is found that is not equal to R. At step 1309 the index value is set to the position of the first parent IP address range which is not equal to R. These steps are necessary in case there are duplicate IP address ranges in the sorted list which are equal to the IP address R. After this, processing proceeds to Block E and step 1312, which is discussed further below.

If at step 1307 it is determined that the operation is a containment-equals operation, then processing proceeds to Block D and step 1310. Since the operation is containment-equals, any additional IP address ranges in the sorted list s_sorted must be identified which are equal to the IP address R. At step 1310 it is determined whether any parents of the IP address range at position index in the sorted list of IP address ranges is equal to R. This determination can be made by traversing the parents using the list of parent pointers. If there are no parent IP address ranges which are equal to R, then processing proceeds to Block E and step 1312. Otherwise, if there are any parent IP address ranges which are equal to IP address R, then at step 1311 the index is set to be the position of the highest parent that is equal to R.

At step 1312 in block E the IP address range at position index in the sorted list of IP address ranges is added to the result list for IP address R if the index value is greater than or equal to zero. If the index value is less than zero then that indicates that there are no IP address ranges in the sorted list which include IP address R. At step 1313, the sorted list of IP address ranges is traversed upwards using the list of parent pointers and all parents of the IP address range at position index are also added to the result list for IP address R.

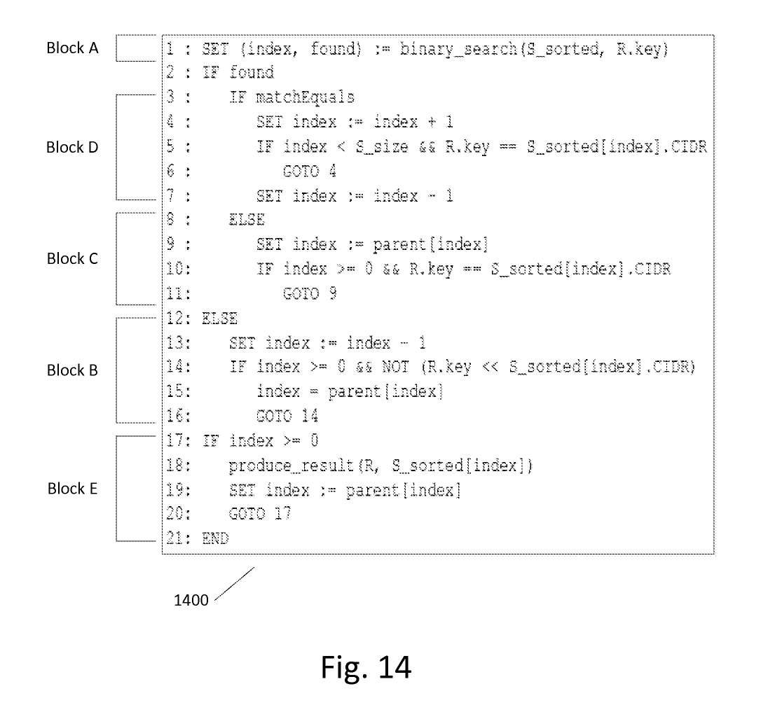

FIG. 14 illustrates an algorithm that can be used to perform the steps shown in FIG. 13. FIG. 14 also indicates the various processing blocks shown in FIG. 13. Specifically, steps 1301 and 1302 are part of Block A, steps 1304, 1305, and 1306 are part of Block B, steps 1308 and 1309 are part of Block C, steps 1310 and 1311 are part of Block D, and steps 1312 and 1313 are part of Block E.

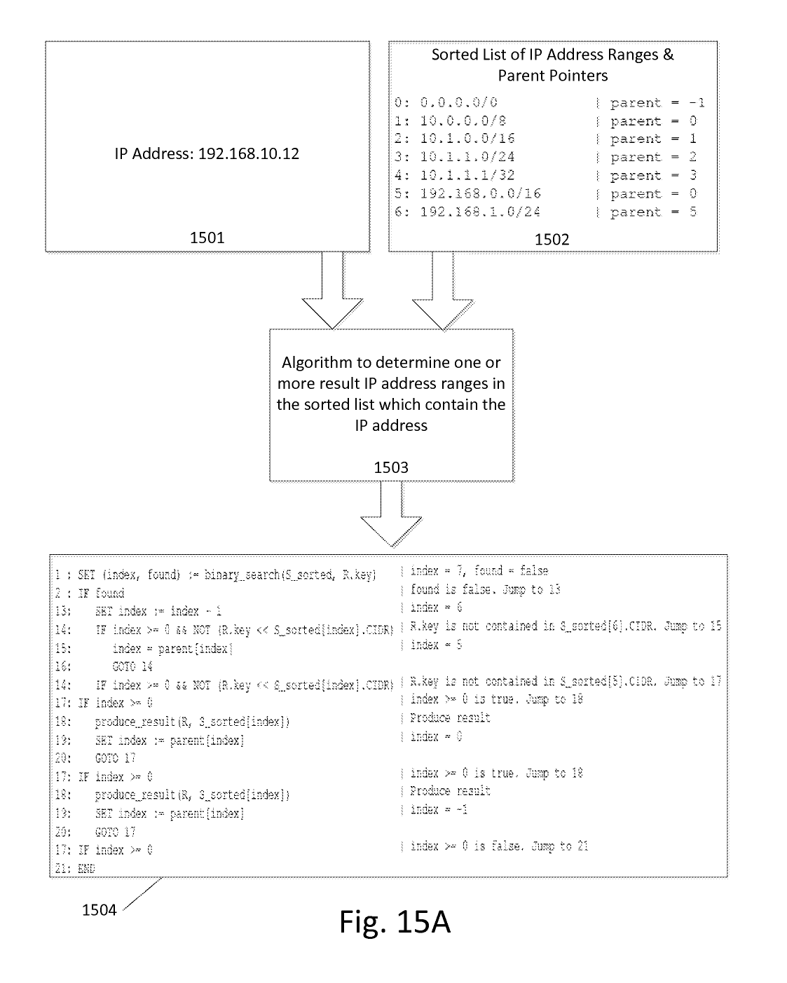

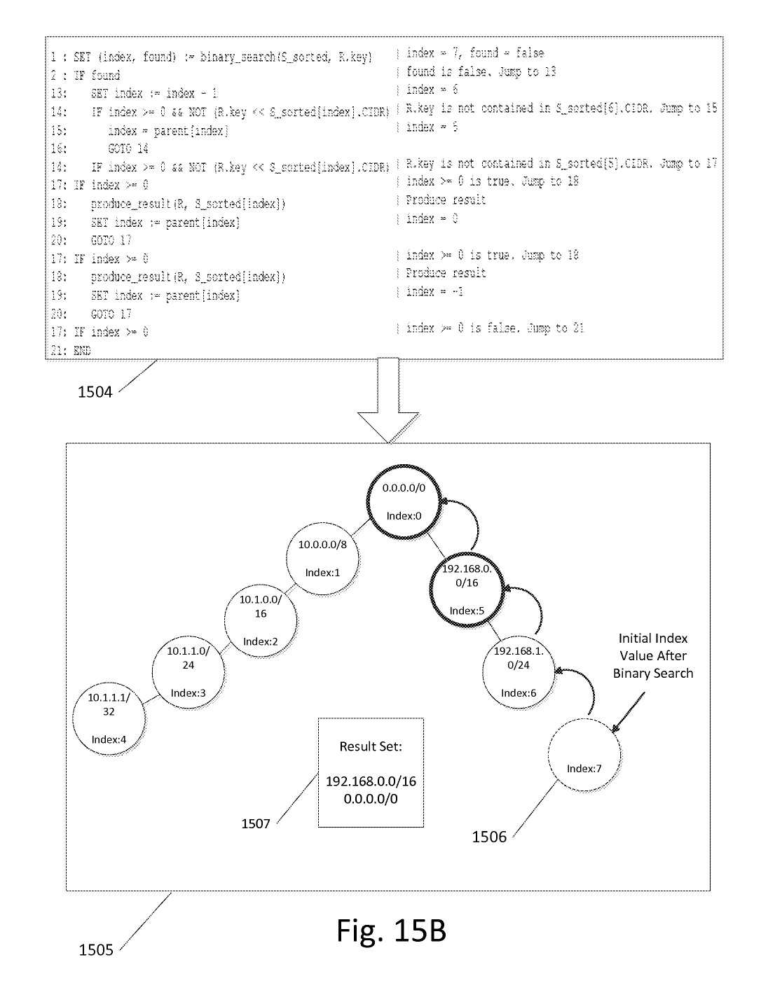

FIG. 15A illustrates an example execution path 1504 of the algorithm shown in FIG. 14 using example IP address 1501 and the sorted list of IP address ranges and parent pointers 1502. IP address 1501 and the sorted list of IP address ranges and parent pointers 1502 are input to the algorithm 1503 (which corresponds to the process and algorithm shown in FIGS. 13-14) and results in execution path 1504, which indicates the lines of code that are executed based on those specific inputs. For example, in this case, the specific IP address 192.168.10.12 would not be found in the sorted list, resulting in execution branching to line 13 of the code. The column on the right side of the execution path provides commentary for each line of code in the execution path.

FIG. 15B provides a graphical representation 1505 of the execution path 1504 using a node tree which represents all of the parent relationships of the IP address ranges in the sorted list. As shown in the graphical representation 1505, after the binary search is performed, no result for IP address 192.168.10.12 is found and the index value would be 7 (where the IP address would have been inserted in the sorted list). This is represented as the dotted circle 1506 which is not an actual node (since no result was found). As shown by the arrow between 1506 and node 192.168.1.0/24 in the graphical representation, the index value is then decremented from 7 to 6. This corresponds to line 13 in the execution path 1504.

The IP address range for node 192.168.1.0/24 is then checked to see if it contains the IP address 192.168.10.12. This corresponds to the first instance of line 14 in the execution path 1504. Since it does not (192.168.10.12 is not contained within 192.168.1.0/24), the index then moves to the parent of that node, shown as the arrow between node 192.168.1.0/24 and node 192.168.0.0/16 in graphical representation 1505. This corresponds to line 15 of the execution path 1504.

The IP address range for node 192.168.0.0/16 is then checked to see if it contains the IP address 192.168.10.12. This corresponds to the second instance of line 14 in the execution path 1504. Since the IP address range for node 192.168.0.0/16 does contain IP address 192.168.10.12, processing then proceeds to block E, the production of the result set, indicated by the first instance of line 17 in the execution path 1504.

Shown in the graphical representation 1505 by darkened circles, node 192.168.0.0/16 is added to the result set and the parent pointer of that node is also traversed to add node 0.0.0.0/0 to the result set. This leaves a final result set 1507 for the IP address 192.168.10.12 which includes two IP address ranges in the sorted list of IP address ranges.

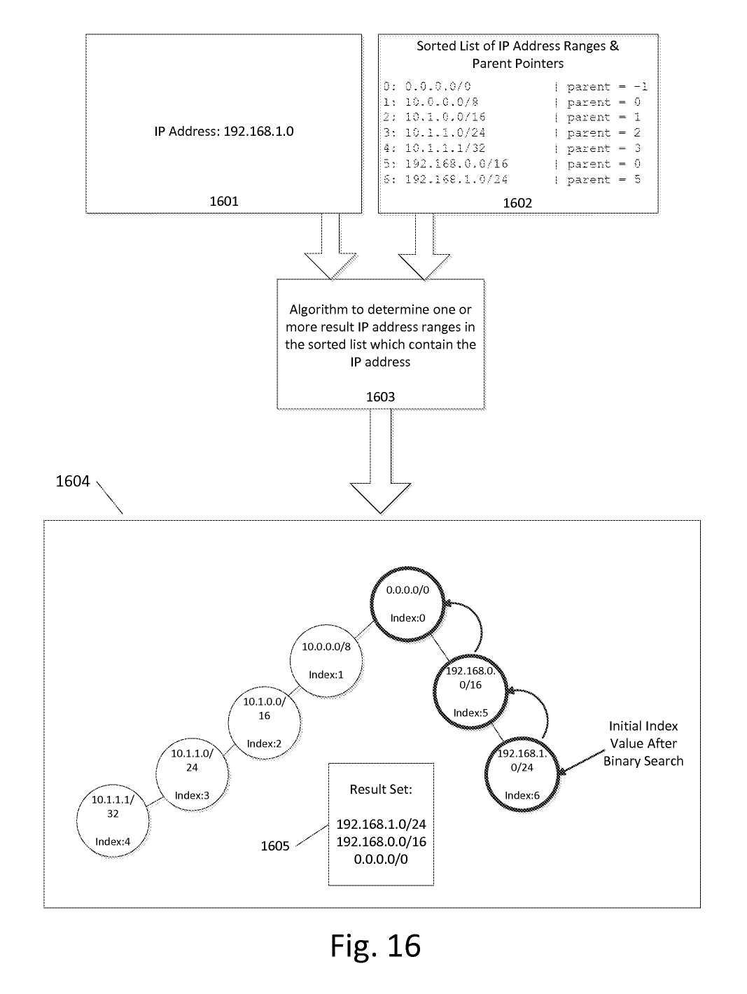

FIG. 16 provides a similar graphical representation of 1604 of the execution of the algorithm 1603 to determine one or more result IP address ranges with the input of the same sorted list 1602 of IP address ranges and parent pointers and a different IP address 1601 which is 192.168.1.0.

In this case, the IP address 192.168.1.0 is found in the sorted list, resulting in an initial index value of 6. For the purpose of this example, it is assumed that the operator is containment equals. As a result, since the IP address has been found and there are no duplicates, the result set 1605 will be produced by traversing up the node tree shown in graphical representation 1604 using parent pointers from the initial index value. This leads to nodes 192.168.1.0/24, 192.168.0.0/16, and 0.0.0.0/0 being added to the results set 1605.

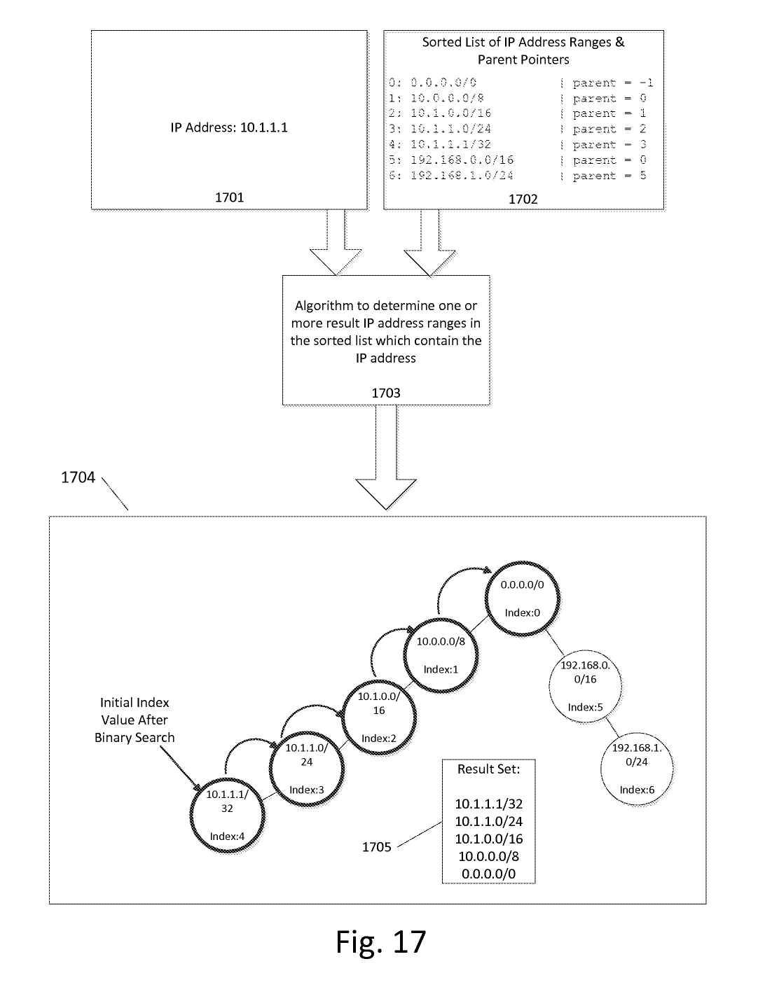

FIG. 17 provides a similar graphical representation of 1704 of the execution of the algorithm 1703 to determine one or more result IP address ranges with the input of the same sorted list 1702 of IP address ranges and parent pointers and a different IP address 1701 which is 10.1.1.1.

In this case, the IP address 10.1.1.1 is found in the sorted list, resulting in an initial index value of 4. For the purpose of this example, it is assumed that the operator is containment equals. As a result, since the IP address has been found and there are no duplicates, the result set 1705 will be produced by traversing up the node tree shown in graphical representation 1704 using parent pointers from the initial index value. This leads to nodes 10.1.1.1/32, 10.1.1.0/24, 10.1.0.0/16, 10.0.0.0/8, and 0.0.0.0/0 being added to the results set 1705.

The method for identifying IP address ranges which contain an IP address described above provides tremendous improvements in processing time and reduction in computational complexity compared to other traditional methods. In addition to the benefit of logarithmic search time made possible by the binary search of the sorted list, only a single binary search needs to be made for each IP address due to the previously compiled parent pointer information for each of the IP address ranges in the sorted list.

In particular, given a number of first join keys R and a number of second join keys S, the cost vector (CV) for this join operation would be given as: CV=[log(S)*(R+S)+S*W+R, 0, 0], where W is the width of the values being compared and the cost vector specifies [CPU cost, Input/Output cost, Network cost].

In addition to performing containment joins, the above described methods and systems can also be utilized for efficient implementation of packet routing rules in IP routers to match the target IP Address of a packet to an interface identified by a CIDR. Additionally, the method can be utilized with any type of IP address, including IPv4 addresses which utilize 32 bits or IPv6 addresses which utilize 128 bits.

Furthermore, in addition to identification of IP address ranges (such as those denoted in CIDR notation) which contain a particular IP address (subnet identification), the above described methods and systems can be applied to any area where prefix identification is performed by substituting into the above-described methods a given prefix for the IP address and a dictionary of strings for the plurality of IP address ranges.

For example, the disclosed methods and systems can be used for efficiently finding all strings that are prefixes of a given string from a dictionary. By specifying two functions:

<<: A partial order over the domain of the join keys to be used to perform the join; and

<: A total order over the domain of join keys that is consistent with <<

The above algorithms can match values (X) with those in a dictionary (Y) such that X.key <<Y.key. In this case, << can be defined as “isPrefixedBy” and < as the lexical comparator of strings to perform a prefix join over the domain of strings.

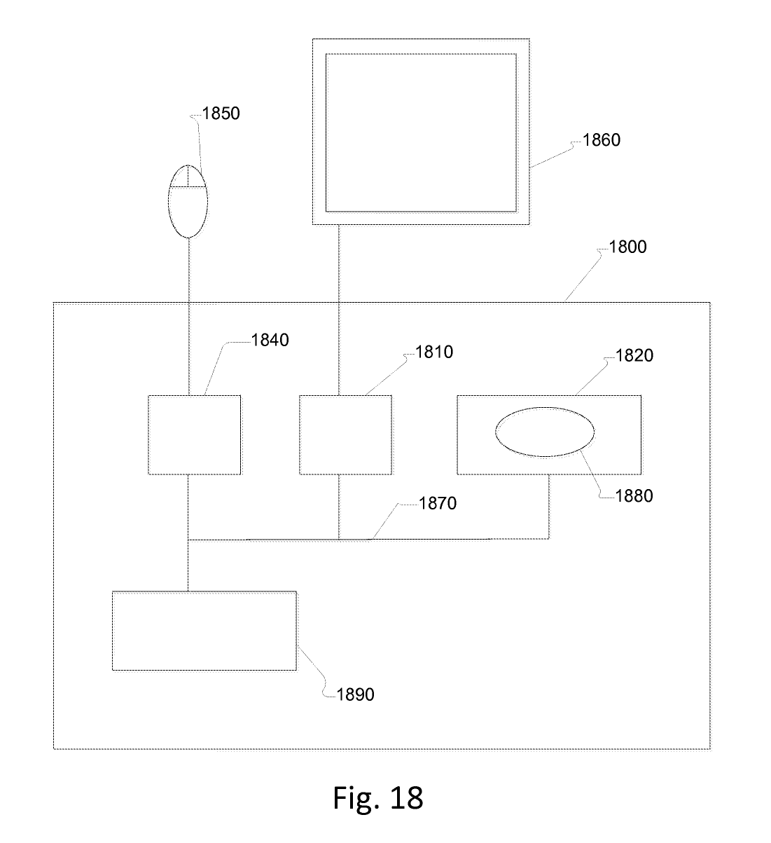

One or more of the above-described techniques can be implemented in or involve one or more computer systems. FIG. 18 illustrates a generalized example of a computing environment 1800. The computing environment 1800 is not intended to suggest any limitation as to scope of use or functionality of a described embodiment.

With reference to FIG. 18, the computing environment 1800 includes at least one processing unit 1810 and memory 1820. The processing unit 1810 executes computer-executable instructions and may be a real or a virtual processor. In a multi-processing system, multiple processing units execute computer-executable instructions to increase processing power. The memory 1820 may be volatile memory (e.g., registers, cache, RAM), non-volatile memory (e.g., ROM, EEPROM, flash memory, etc.), or some combination of the two. The memory 1820 may store software instructions 1880 for implementing the described techniques when executed by one or more processors. Memory 1820 can be one memory device or multiple memory devices.

A computing environment may have additional features. For example, the computing environment 1800 includes storage 1840, one or more input devices 1850, one or more output devices 1860, and one or more communication connections 1890. An interconnection mechanism 1870, such as a bus, controller, or network interconnects the components of the computing environment 1800. Typically, operating system software or firmware (not shown) provides an operating environment for other software executing in the computing environment 1800, and coordinates activities of the components of the computing environment 1800.

The storage 1840 may be removable or non-removable, and includes magnetic disks, magnetic tapes or cassettes, CD-ROMs, CD-RWs, DVDs, or any other medium which can be used to store information and which can be accessed within the computing environment 1800. The storage 1840 may store instructions for the software 1880.

The input device(s) 1850 may be a touch input device such as a keyboard, mouse, pen, trackball, touch screen, or game controller, a voice input device, a scanning device, a digital camera, remote control, or another device that provides input to the computing environment 1800. The output device(s) 1860 may be a display, television, monitor, printer, speaker, or another device that provides output from the computing environment 1800.

The communication connection(s) 1890 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1800, computer-readable media include memory 1820, storage 1840, communication media, and combinations of any of the above.

Of course, FIG. 18 illustrates computing environment 1800, display device 1860, and input device 1850 as separate devices for ease of identification only. Computing environment 1800, display device 1860, and input device 1850 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1800 may be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method executed by one or more computing devices for efficient subnet identification, the method comprising:
sorting, by at least one of the one or more computing devices, a plurality of Internet Protocol (IP) address ranges to generate a sorted list of IP address ranges; and
determining, by at least one of the one or more computing devices, one or more result IP address ranges in the sorted list of IP address ranges which contain an IP address based at least in part on one or more binary searches of the sorted list of IP address ranges, wherein the one or more binary searches utilize one or more search keys that are based at least in part on the IP address.

2. The method of claim 1, wherein sorting the plurality of IP address ranges comprises:
comparing a first bit string corresponding to a first IP address range in the plurality of IP address ranges with a second bit string corresponding to a second IP address range in the plurality of IP address ranges; and
sorting the first IP address range and the second IP address range based at least in part on the comparison.

3. The method of claim 1, wherein sorting the plurality of IP address ranges comprises:
storing a first IP address range in the plurality of IP address ranges as a first fixed-width byte sequence;
storing a second IP address range in the plurality of IP address ranges as a second fixed-width byte sequence;
comparing the first fixed-width byte sequence with the second fixed-width byte sequence; and
sorting the first IP address range and the second IP address range based at least in part on the comparison.

4. The method of claim 1, wherein the plurality of IP address ranges are sorted in ascending lexicographic order.

5. The method of claim 1, wherein each IP address range in the plurality of IP address ranges comprises an IP address and an associated network mask.

6. The method of claim 1, wherein each IP address range in the plurality of IP address ranges is expressed in Classless Inter-Domain Routing (CIDR) notation.

7. The method of claim 1, wherein determining one or more result IP address ranges in the sorted list of IP address ranges which include an IP address based at least in part on one or more binary searches of the sorted list of IP address ranges comprises:
generating a plurality of search keys from the IP address, wherein each search key in the plurality of search keys incorporates a unique number of significant bits from the IP address and wherein the total number of search keys is equal to the total number of significant bits in the IP address; and
performing a plurality of binary searches of the sorted list of IP address ranges using the plurality of search keys to identify any IP address ranges in the sorted list of IP address ranges which match the plurality of search keys.

8. The method of claim 1, wherein determining one or more result IP address ranges in the sorted list of IP address ranges which include an IP address based at least in part on one or more binary searches of the sorted list of IP address ranges comprises:
generating a list of parent pointers corresponding to the sorted list IP of address ranges, wherein each parent pointer in the list of parent pointers corresponds to an IP address range in the sorted list of IP address ranges and points to either another IP address range in the sorted list IP of address ranges or a terminal node;
performing a binary search on the sorted list of IP address ranges using the IP address as a search key, wherein the binary search returns a flag indicating whether the sorted list of IP address ranges contains the search key and an index value corresponding to either a location of the search key in the sorted list of IP address ranges or a search index value at termination of the binary search; and
determining the one or more result IP address ranges based at least in part on the flag, the index value, the sorted list of IP address ranges, and the list of parent pointers.

9. The method of claim 8, wherein each parent pointer in the list of parent pointers points to either a terminal node or to an IP address range in the sorted list IP of address ranges which encompasses the IP address range corresponding to that parent pointer and which is the next largest IP address range in the sorted list IP of address ranges.

10. The method of claim 8, further comprising:
receiving, by at least one of the one or more computing devices, an input indicating a strict containment operation.

11. The method of claim 10, wherein determining the one or more result IP address ranges based at least in part on the flag, the index value, the sorted list of IP address ranges, and the list of parent pointers comprises:
identifying a first IP address range corresponding to the index value in the sorted list of IP address ranges based at least in part on a determination that the flag is true;
identifying a second IP address range that is a parent of the IP address range corresponding to the index value based at least in part on the sorted list of IP address ranges and the list of parent pointers;
adding the second IP address range to the one or more result IP address ranges based at least in part on a determination that the second IP address range is not equal to the search key;
identifying one or more third IP address ranges that are parents of the second IP address range based at least in part on the sorted list of IP address ranges and the list of parent pointers; and
adding the one or more third IP address ranges to the one or more result IP address ranges.

12. The method of claim 8, wherein determining the one or more result IP address ranges based at least in part on the flag, the index value, the sorted list of IP address ranges, and the list of parent pointers comprises:
adding an IP address range corresponding to the index value in the sorted list of IP address ranges to the one or more result IP address ranges based at least in part on a determination that the flag is true;
identifying one or more additional IP address ranges that are parents of the IP address range corresponding to the index value based at least in part on the sorted list of IP address ranges and the list of parent pointers; and
adding the one or more additional IP address ranges to the one or more result IP address ranges.

13. The method of claim 12, wherein determining the one or more result IP address ranges based at least in part on the flag, the index value, the sorted list of IP address ranges, and the list of parent pointers further comprises:
determining whether an IP address range located immediately after the IP address range corresponding to the index value in the sorted list of IP address ranges is equal to the search key; and
adding the IP address range located immediately after the IP address range corresponding to the index value in the sorted list of IP address ranges to the one or more result IP address ranges based at least in part on a determination that it is equal to the search key.

14. The method of 8, wherein determining the one or more result IP address ranges based at least in part on the flag, the index value, the sorted list of IP address ranges, and the list of parent pointers comprises:
decrementing the index value based at least in part on a determination that the flag is false;
determining whether an IP address range corresponding to the decremented index value in the sorted list of IP address ranges contains the search key;
adding the IP address range corresponding to the decremented index value to the one or more result IP address ranges based at least in part on a determination that the IP address range corresponding to the decremented index value contains the search key;
identifying one or more additional IP address ranges that are parents of the IP address range corresponding to the decremented index value based at least in part on the sorted list of IP address ranges and the list of parent pointers; and
adding the one or more additional IP address ranges to the one or more result IP address ranges.

15. An apparatus for efficient subnet identification, the apparatus comprising:
one or more processors; and
one or more memories operatively coupled to at least one of the one or more processors and having instructions stored thereon that, when executed by at least one of the one or more processors, cause at least one of the one or more processors to:
sort a plurality of Internet Protocol (IP) address ranges to generate a sorted list of IP address ranges; and
determine one or more result IP address ranges in the sorted list of IP address ranges which contain an IP address based at least in part on one or more binary searches of the sorted list of IP address ranges, wherein the one or more binary searches utilize one or more search keys that are based at least in part on the IP address.

16. The apparatus of claim 15, wherein the instructions that, when executed by at least one of the one or more processors, cause at least one of the one or more processors to sort the plurality of IP address ranges further cause at least one of the one or more processors to:
compare a first bit string corresponding to a first IP address range in the plurality of IP address ranges with a second bit string corresponding to a second IP address range in the plurality of IP address ranges; and
sort the first IP address range and the second IP address range based at least in part on the comparison.

17. The apparatus of claim 15, wherein the instructions that, when executed by at least one of the one or more processors, cause at least one of the one or more processors to sort the plurality of IP address ranges further cause at least one of the one or more processors to:
store a first IP address range in the plurality of IP address ranges as a first fixed-width byte sequence;
store a second IP address range in the plurality of IP address ranges as a second fixed-width byte sequence;
compare the first fixed-width byte sequence with the second fixed-width byte sequence; and
sort the first IP address range and the second IP address range based at least in part on the comparison.

18. The apparatus of claim 15, wherein the plurality of IP address ranges are sorted in ascending lexicographic order.

19. The apparatus of claim 15, wherein each IP address range in the plurality of IP address ranges comprises an IP address and an associated network mask.

20. The apparatus of claim 15, wherein each IP address range in the plurality of IP address ranges is expressed in Classless Inter-Domain Routing (CIDR) notation.

21. The apparatus of claim 15, wherein the instructions that, when executed by at least one of the one or more processors, cause at least one of the one or more processors to determine one or more result IP address ranges in the sorted list of IP address ranges which include an IP address based at least in part on one or more binary searches of the sorted list of IP address ranges further cause at least one of the one or more processors to:
generate plurality of search keys from the IP address, wherein each search key in the plurality of search keys incorporates a unique number of significant bits from the IP address and wherein the total number of search keys is equal to the total number of significant bits in the IP address; and
perform a plurality of binary searches of the sorted list of IP address ranges using the plurality of search keys to identify any IP address ranges in the sorted list of IP address ranges which match the plurality of search keys.

22. The apparatus of claim 15, wherein the instructions that, when executed by at least one of the one or more processors, cause at least one of the one or more processors to determine one or more result IP address ranges in the sorted list of IP address ranges which include an IP address based at least in part on one or more binary searches of the sorted list of IP address ranges further cause at least one of the one or more processors to:
generate a list of parent pointers corresponding to the sorted list IP of address ranges, wherein each parent pointer in the list of parent pointers corresponds to an IP address range in the sorted list of IP address ranges and points to either another IP address range in the sorted list IP of address ranges or a terminal node;
perform a binary search on the sorted list of IP address ranges using the IP address as a search key, wherein the binary search returns a flag indicating whether the sorted list of IP address ranges contains the search key and an index value corresponding to either a location of the search key in the sorted list of IP address ranges or a search index value at termination of the binary search; and
determine the one or more result IP address ranges based at least in part on the flag, the index value, the sorted list of IP address ranges, and the list of parent pointers.

23. The apparatus of claim 22, wherein each parent pointer in the list of parent pointers points to either a terminal node or to an IP address range in the sorted list IP of address ranges which encompasses the IP address range corresponding to that parent pointer and which is the next largest IP address range in the sorted list IP of address ranges.

24. The apparatus of claim 22, wherein at least one of the one or more memories has further instructions stored thereon that, when executed by at least one of the one or more processors, cause at least one of the one or more processors to:
receive an input indicating a strict containment operation.

25. The apparatus of claim 24, wherein the instructions that, when executed by at least one of the one or more processors, cause at least one of the one or more processors to determine the one or more result IP address ranges based at least in part on the flag, the index value, the sorted list of IP address ranges, and the list of parent pointers further cause at least one of the one or more processors to:
identify a first IP address range corresponding to the index value in the sorted list of IP address ranges based at least in part on a determination that the flag is true;
identify a second IP address range that is a parent of the IP address range corresponding to the index value based at least in part on the sorted list of IP address ranges and the list of parent pointers;
add the second IP address range to the one or more result IP address ranges based at least in part on a determination that the second IP address range is not equal to the search key;
identify one or more third IP address ranges that are parents of the second IP address range based at least in part on the sorted list of IP address ranges and the list of parent pointers; and
add the one or more third IP address ranges to the one or more result IP address ranges.

26. The apparatus of claim 22, wherein the instructions that, when executed by at least one of the one or more processors, cause at least one of the one or more processors to determine the one or more result IP address ranges based at least in part on the flag, the index value, the sorted list of IP address ranges, and the list of parent pointers further cause at least one of the one or more processors to:
add an IP address range corresponding to the index value in the sorted list of IP address ranges to the one or more result IP address ranges based at least in part on a determination that the flag is true;
identify one or more additional IP address ranges that are parents of the IP address range corresponding to the index value based at least in part on the sorted list of IP address ranges and the list of parent pointers; and
add the one or more additional IP address ranges to the one or more result IP address ranges.

27. The apparatus of claim 26, wherein the instructions that, when executed by at least one of the one or more processors, cause at least one of the one or more processors to determine the one or more result IP address ranges based at least in part on the flag, the index value, the sorted list of IP address ranges, and the list of parent pointers further cause at least one of the one or more processors to:
determine whether an IP address range located immediately after the IP address range corresponding to the index value in the sorted list of IP address ranges is equal to the search key; and
add the IP address range located immediately after the IP address range corresponding to the index value in the sorted list of IP address ranges to the one or more result IP address ranges based at least in part on a determination that it is equal to the search key.

28. The apparatus of claim 22, wherein the instructions that, when executed by at least one of the one or more processors, cause at least one of the one or more processors to determine the one or more result IP address ranges based at least in part on the flag, the index value, the sorted list of IP address ranges, and the list of parent pointers further cause at least one of the one or more processors to:
decrement the index value based at least in part on a determination that the flag is false;
determine whether an IP address range corresponding to the decremented index value in the sorted list of IP address ranges contains the search key;
add the IP address range corresponding to the decremented index value to the one or more result IP address ranges based at least in part on a determination that the IP address range corresponding to the decremented index value contains the search key;
identify one or more additional IP address ranges that are parents of the IP address range corresponding to the decremented index value based at least in part on the sorted list of IP address ranges and the list of parent pointers; and
add the one or more additional IP address ranges to the one or more result IP address ranges.

29. At least one non-transitory computer-readable medium storing computer-readable instructions that, when executed by one or more computing devices, cause at least one of the one or more computing devices to:
sort a plurality of Internet Protocol (IP) address ranges to generate a sorted list of IP address ranges; and
determine one or more result IP address ranges in the sorted list of IP address ranges which contain an IP address based at least in part on one or more binary searches of the sorted list of IP address ranges, wherein the one or more binary searches utilize one or more search keys that are based at least in part on the IP address.

30. The at least one non-transitory computer-readable medium of claim 29, wherein the instructions that, when executed by at least one of the one or more computing devices, cause at least one of the one or more computing devices to sort the plurality of IP address ranges further cause at least one of the one or more computing devices to:
compare a first bit string corresponding to a first IP address range in the plurality of IP address ranges with a second bit string corresponding to a second IP address range in the plurality of IP address ranges; and
sort the first IP address range and the second IP address range based at least in part on the comparison.

31. The at least one non-transitory computer-readable medium of claim 29, wherein the instructions that, when executed by at least one of the one or more computing devices, cause at least one of the one or more computing devices to sort the plurality of IP address ranges further cause at least one of the one or more computing devices to:
store a first IP address range in the plurality of IP address ranges as a first fixed-width byte sequence;
store a second IP address range in the plurality of IP address ranges as a second fixed-width byte sequence;
compare the first fixed-width byte sequence with the second fixed-width byte sequence; and
sort the first IP address range and the second IP address range based at least in part on the comparison.

32. The at least one non-transitory computer-readable medium of claim 29, wherein the plurality of IP address ranges are sorted in ascending lexicographic order.

33. The at least one non-transitory computer-readable medium of claim 29, wherein each IP address range in the plurality of IP address ranges comprises an IP address and an associated network mask.

34. The at least one non-transitory computer-readable medium of claim 29, wherein each IP address range in the plurality of IP address ranges is expressed in Classless Inter-Domain Routing (CIDR) notation.

35. The at least one non-transitory computer-readable medium of claim 29, wherein the instructions that, when executed by at least one of the one or more computing devices, cause at least one of the one or more computing devices to determine one or more result IP address ranges in the sorted list of IP address ranges which include an IP address based at least in part on one or more binary searches of the sorted list of IP address ranges further cause at least one of the one or more computing devices to:
generate plurality of search keys from the IP address, wherein each search key in the plurality of search keys incorporates a unique number of significant bits from the IP address and wherein the total number of search keys is equal to the total number of significant bits in the IP address; and
perform a plurality of binary searches of the sorted list of IP address ranges using the plurality of search keys to identify any IP address ranges in the sorted list of IP address ranges which match the plurality of search keys.

36. The at least one non-transitory computer-readable medium of claim 29, wherein the instructions that, when executed by at least one of the one or more computing devices, cause at least one of the one or more computing devices to determine one or more result IP address ranges in the sorted list of IP address ranges which include an IP address based at least in part on one or more binary searches of the sorted list of IP address ranges further cause at least one of the one or more computing devices to:
generate a list of parent pointers corresponding to the sorted list IP of address ranges, wherein each parent pointer in the list of parent pointers corresponds to an IP address range in the sorted list of IP address ranges and points to either another IP address range in the sorted list IP of address ranges or a terminal node;
perform a binary search on the sorted list of IP address ranges using the IP address as a search key, wherein the binary search returns a flag indicating whether the sorted list of IP address ranges contains the search key and an index value corresponding to either a location of the search key in the sorted list of IP address ranges or a search index value at termination of the binary search; and
determine the one or more result IP address ranges based at least in part on the flag, the index value, the sorted list of IP address ranges, and the list of parent pointers.

37. The at least one non-transitory computer-readable medium of claim 36, wherein each parent pointer in the list of parent pointers points to either a terminal node or to an IP address range in the sorted list IP of address ranges which encompasses the IP address range corresponding to that parent pointer and which is the next largest IP address range in the sorted list IP of address ranges.

38. The at least one non-transitory computer-readable medium of claim 36, further storing computer-readable instructions that, when executed by at least one of the one or more computing devices, cause at least one of the one or more computing devices to:
receive an input indicating a strict containment operation.

39. The at least one non-transitory computer-readable medium of claim 38, wherein the instructions that, when executed by at least one of the one or more computing devices, cause at least one of the one or more computing devices to determine the one or more result IP address ranges based at least in part on the flag, the index value, the sorted list of IP address ranges, and the list of parent pointers further cause at least one of the one or more computing devices to:
identify a first IP address range corresponding to the index value in the sorted list of IP address ranges based at least in part on a determination that the flag is true;
identify a second IP address range that is a parent of the IP address range corresponding to the index value based at least in part on the sorted list of IP address ranges and the list of parent pointers;
add the second IP address range to the one or more result IP address ranges based at least in part on a determination that the second IP address range is not equal to the search key;
identify one or more third IP address ranges that are parents of the second IP address range based at least in part on the sorted list of IP address ranges and the list of parent pointers; and
add the one or more third IP address ranges to the one or more result IP address ranges.

40. The at least one non-transitory computer-readable medium of claim 36, wherein the instructions that, when executed by at least one of the one or more computing devices, cause at least one of the one or more computing devices to determine the one or more result IP address ranges based at least in part on the flag, the index value, the sorted list of IP address ranges, and the list of parent pointers further cause at least one of the one or more computing devices to:
add an IP address range corresponding to the index value in the sorted list of IP address ranges to the one or more result IP address ranges based at least in part on a determination that the flag is true;
identify one or more additional IP address ranges that are parents of the IP address range corresponding to the index value based at least in part on the sorted list of IP address ranges and the list of parent pointers; and
add the one or more additional IP address ranges to the one or more result IP address ranges.

41. The at least one non-transitory computer-readable medium of claim 40, wherein the instructions that, when executed by at least one of the one or more computing devices, cause at least one of the one or more computing devices to determine the one or more result IP address ranges based at least in part on the flag, the index value, the sorted list of IP address ranges, and the list of parent pointers further cause at least one of the one or more computing devices to:
determine whether an IP address range located immediately after the IP address range corresponding to the index value in the sorted list of IP address ranges is equal to the search key; and
add the IP address range located immediately after the IP address range corresponding to the index value in the sorted list of IP address ranges to the one or more result IP address ranges based at least in part on a determination that it is equal to the search key.

42. The at least one non-transitory computer-readable medium of claim 36, wherein the instructions that, when executed by at least one of the one or more computing devices, cause at least one of the one or more computing devices to determine the one or more result IP address ranges based at least in part on the flag, the index value, the sorted list of IP address ranges, and the list of parent pointers further cause at least one of the one or more computing devices to:
decrement the index value based at least in part on a determination that the flag is false;
determine whether an IP address range corresponding to the decremented index value in the sorted list of IP address ranges contains the search key;
add the IP address range corresponding to the decremented index value to the one or more result IP address ranges based at least in part on a determination that the IP address range corresponding to the decremented index value contains the search key;
identify one or more additional IP address ranges that are parents of the IP address range corresponding to the decremented index value based at least in part on the sorted list of IP address ranges and the list of parent pointers; and
add the one or more additional IP address ranges to the one or more result IP address ranges.
